(19) United States
(12) Patent Application Publication
(10) Pub. No.: US 2017/0173831 A1
(43) Pub. Date: Jun. 22, 2017

(54) Insert for an Injection-Moulding Nozzle and Injection-Moulding Nozzle Having Such an Insert

(71) Applicant: GÜNTHER Heisskanaltechnik GmbH, Frankenberg (DE)

(72) Inventors: Herbert GÜNTHER, Allendorf (DE); Siegrid SOMMER, Burgwald (DE); Torsten SCHNELL, Lichtenfels (DE)

(21) Appl. No.: 15/388,287

(22) Filed: Dec. 22, 2016

(30) Foreign Application Priority Data
Dec. 22, 2015 (DE) 10 2015 122 655.3

(51) Int. Cl. B29C 45/03

(52) U.S. Cl. CPC B29C 45/03; B29C 2045/0074

(57) ABSTRACT

An insert for an injection-moulding nozzle, having an insert body which has a rear end and a front end and in which at least one flow duct is formed between the rear end and the front end. In this case, the insert body has a first part for arranging the insert on or in the injection-moulding nozzle and a second part for arranging on or in a mould insert. The first part is manufactured from a first material and extends from the rear end of the insert body to a contact surface. The second part is manufactured from a material different from the first material and extends from the contact surface to the front end of the insert body. Furthermore, the first part and the second part are connected firmly together at and/or along the contact surface. Also disclosed, an injection-moulding nozzle can include the insert.

### CROSS-REFERENCE TO RELATED APPLICATIONS

This application claims priority to German Patent Application No. 10 2015 122 655.3, filed Dec. 22, 2015, entitled “Insert for an Injection-Moulding Nozzle and Injection-Moulding Nozzle Having Such an Insert,” which is incorporated by reference herein in its entirety.

### FIELD OF INVENTION

The invention relates to an insert for an injection-moulding nozzle, and to an injection-moulding nozzle having an insert.

### BACKGROUND

Injection-moulding nozzles, in particular hot runner nozzles, are used in injection moulds in order to feed a flowable compound, for example a plastics material, to a separable mould insert at a predetermined temperature under high pressure. They usually have a material tube having a flow duct which is connected in terms of flow to a distribution duct in a distribution plate via an inlet opening and leads out via an outlet opening in the sprue opening of the mould insert (mould impression).

In order that the flowable material does not cool prematurely within the flow duct of the hot runner nozzle, a heating device is provided which is placed on or attached to the outside of the material tube. In order furthermore for the flowable compound to be kept at a uniform temperature right up to the sprue opening, a heat conducting sleeve made of a highly heat-conductive material is inserted into the end of the material tube, said heat conducting sleeve continuing the flow duct and forming the outlet opening for the injection-moulding nozzle at its end.

In the case of an open nozzle, the heat conductive sleeve is usually configured as a nozzle mouthpiece and is provided with a nozzle tip which ends with its conical tip at or shortly before the plane of the sprue opening. In the case of a needle valve nozzle, a sealing seat for a shut-off needle is formed at the end in the outlet opening of the heat conducting sleeve, said shut-off needle being movable back and forth between an open and a closed position by means of a needle drive.

In the processing of abrasive materials or of injection-moulding compounds which are filled with abrasive constituents, severe wear can occur to the heat conducting sleeve, in particular at the outlet opening, such that the heat conducting sleeve or—depending on the design—the entire hot runner nozzle has to be replaced relatively frequently. In particular in the case of needle valve nozzles, damage occurs at the sealing seat for the shut-off needle, such that the latter can no longer be guided exactly in its periodic movement from an open position into a closed position and the outlet opening can no longer be closed in a sealed manner.

In order to avoid this wear, WO 2005/018906 A1 proposes an insert which is preferably made of wear-resistant material. Said insert is arranged at the mould-insert-side end of a nozzle mouthpiece and configured to be longitudinally displaceable either by itself or together with the nozzle mouthpiece. During operation of the injection-moulding nozzle, the insert is clamped in place between the nozzle body and the mould insert. The insert serves to protect the nozzle mouthpiece from severe wear and optimizes needle guidance in needle valve nozzles, since it acts as a centring body both for the shut-off needle and for the nozzle.

A disadvantage here is that the insert can be manufactured only from a single material. Therefore, the insert consists either of wear-resistant material or a highly heat-conductive material is used—as in another embodiment in WO 2005/018906 A1.

WO 2003/070446 A1 also proposes an insert which acts as a valve needle guide and as a wear protection means. In addition to the embodiment already known from WO 2005/018906 A1 with a one-piece insert made either of thermally insulating material or thermally conductive material, WO 2003/070446 A1 proposes a two-part embodiment of the insert, in which the two individual parts of the insert can have different material properties. In this case, for example an outer part (insulating part) made of a thermally insulating material and an inner part (guide part) made of a thermally conductive material or of a wear-resistant material are proposed. The thermally insulating material is used in order to reduce heat losses to the mould insert and the thermally conductive material is used in order to conduct heat from the tip to the melt in the guide opening.

A disadvantage with this embodiment is that the individual parts of the insert are produced separately from the different materials and have to be mounted individually in the injection-moulding nozzle. Also, in the event of a necessary replacement, both parts have to be removed separately. This increases the amount of work and the assembly costs. Furthermore, it is possible for the two individual parts to become worn with different degrees of severity, this being impractical for use and causing additional effort in the maintenance and inspection of the injection mould. A further disadvantage is that the two- or multipart inserts have relatively large dimensions, this having an unfavourable effect on the overall size of the hot runner nozzle and thus having an unfavourable effect on the pitches or impression spacings that are realizable.

The aim of the invention is to overcome this and further disadvantages of the prior art and to create a compact insert for an injection-moulding nozzle which makes several material properties usable in a single component and allows a small overall size of the injection-moulding nozzle. In particular, it is intended to be constructed in a cost-effective manner with simple means while having small dimensions and to be easy to use within the mould. The insert is furthermore intended to durably withstand the high variation in stress as a result of cooling and heating up.

The main features of the invention are specified in the independent claims, and more specific configurations are the subject matter of the dependent claims.

In an insert for an injection-moulding nozzle, having an insert body which has a rear end and a front end and in which at least one flow duct is formed between the rear end and the front end, wherein the insert body has a first part for arranging the insert on or in the injection-moulding nozzle and a second part for arranging on or in a mould insert, the invention provides for the first part to be manufactured from a first material and to extend from the rear end of the insert body to a contact surface, and for the second part to be manufactured from a material different from the first material and to extend from the contact surface to the front end of the insert body, wherein the first part and the second part are connected together at and/or along the contact surface.

Thus, it is possible to combine several material properties in only one component, which is inserted for example into the lower, mould-impression-side end of a material tube or of a heat conducting sleeve of the injection-moulding nozzle, and to use said material properties for the injection-moulding nozzle and the flowable material to be processed without several different components having to be required and fitted. In this case, the different materials can be freely selected and assembled in order to meet the particular requirements placed on the insert and the respective injection-moulding nozzle. For example, it is possible to manufacture the first part of the insert from a highly heat-conductive material in order to transport the heat generated by a heater of the injection-moulding nozzle as far as possible to the sprue opening. By contrast, the second part can be manufactured from a wear-resistant material in order to reduce the wear to the insert and thus to increase the lifetime of the injection-moulding nozzle, in particular when the second part of the insert forms the sealing seat for a shut-off needle.

The first part and the second part of the insert can advantageously be manufactured as separate parts which are connected together precisely and firmly after manufacturing. Alternatively, it is also possible first of all to produce a blank made of a composite material of the first and second material and subsequently to manufacture the insert from this composite material. As a result of the connection of the parts, consisting of two different materials, of the insert, the advantageous properties of the materials can be used in a pinpoint manner and to the best possible extent in a very small overall space. High-cost and high-maintenance installation of two individual parts is avoided. Likewise, no complicated sealing elements or sealing surfaces, which could possibly result in leaks at or in the injection-moulding nozzle or in the tool, are required between the two parts. Rather, the two parts are always connected firmly together and the insert forms a single component having minimum dimensions for use.

On account of the contact surface, the connection extends between the two materials used, such that, although the properties of both materials are combined in one component, at the same time, the materials are clearly limited to the different parts. A mixture of the two materials away from the contact surface is avoided. This contributes to optimal and precise use of the materials when an insert is used in an injection-moulding nozzle.

In embodiments of the invention, the first part and the second part are connected together in a cohesive, form-fitting or frictional manner. With a cohesive connection, minimum dimensions can be achieved. However, mechanical connections in the form of a form fit or of a friction fit, for example by locking, screwing, pressing or shrinkage, are also conceivable.

On account of the limited overall space, it is in particular advantageous for the first and the second part to be connected cohesively together by means of welding, preferably by means of diffusion welding or laser welding.

In order to form cohesive connections, in addition to welding, methods such as soldering or adhesive bonding also come into question. Welding has proved to be an optimal method for connecting the first and the second part because the first and the second part are usually formed from a metal material and a reliable and durably stable connection between the parts can be formed by welding. Diffusion welding, in particular, has advantages over other welding methods, here. The quality of the welded connections is extraordinarily high. A pore-free, leaktight composite, which satisfies the highest mechanical, thermal and corrosion-related requirements, is produced. In this case, no additional material has to be used during diffusion welding, and so the joining seam does not exhibit any foreign alloying components and thus has properties similar to a base material in an optimal embodiment. As a result of the lack of a molten phase in the joining process, highly precise and true-to-contour welding can additionally be ensured.

Alternatively, the first part can be connected to the second part by means of a mechanical connecting arrangement. To this end, a locking connection, a screw connection, a press connection or a bayonet connection, inter alia, can be used. Both parts can also be connected together by shrinkage. All the above mentioned types of connection have the advantage that such a connection of the first part to the second part is configured in a durably firm and leaktight manner.

It is particularly advantageous when, according to further embodiments, the first material of the first part is a highly heat-conductive material and the second material of the second part is a wear-resistant material. As a result, it is possible—for example in the region of a needle guide—to reduce the wear to the insert on account of the repeated sliding of the valve needle along the inner walls of the flow duct during operation of the injection-moulding nozzle. At the same time, a highly heat-conductive embodiment of the first part of the insert, which can be arranged for example on a heat conducting sleeve, ensures optimal temperature distribution in the sprue region.

In this case, it has proved advantageous for the heat-conductive material and the wear-resistant material to have high thermal expansion. As a result of the use of a material with high thermal expansion, the insert expands in a targeted manner when the injection mould is heated up, such that, after the operating temperature of the injection-moulding nozzle has been reached, the insert is clamped in place optimally between the material tube and/or heat conducting sleeve on one side and the mould insert on the other side and forms a durably leaktight arrangement.

In a further advantageous design, the material of the first part and the material of the second part have an identical or approximately identical coefficient of expansion.

If the coefficients of expansion of the two parts of the insert are different, the difference between the coefficients of thermal expansion of the heat-conductive material and of the wear-resistant material takes into account the elastic capacities of the connection between the first and the second part, such that the two parts of the insert are always connected together durably and firmly.

In a specific embodiment, the wear-resistant material is a tool steel. This is distinguished by its good wear protection properties. In this case, tool steel is more cost-effective than other materials with comparable wear protection properties. Here, in particular a tool steel having a low heat conductivity can be advantageous, because in this case thermal separation of the plastics melt from the mould insert of the injection mould takes place, thereby avoiding premature cooling of the plastics melt in the region of the second portion. Alternatively, a ceramic, which is distinguished by high wear resistance and low thermal conductivity, could also be used as the wear-resistant material.

In yet another embodiment of the invention, the contact surface, along which the first part is connected to the second part, extends perpendicularly or obliquely to the longitudinal axis of the insert body. This results for example in a plate-like contact surface with minimal expansion. As a result of the perpendicular extension of the contact surface, an optimal connection between the first and the second part can be produced. Alternatively, the contact surface can also extend obliquely to the longitudinal axis of the insert body, for example when a larger contact surface is desired. The latter can be formed for example in a conical manner. As a result of a contact surface oriented obliquely to the longitudinal axis, in particular a cohesive connection can be reinforced, since in this case a larger portion is available as the contact surface.

In an advantageous configuration of the invention, the insert is formed in a rotationally symmetrical manner with respect to a longitudinal axis and has a first portion, a flange and a second portion. In this case, the first portion and/or the second portion can be configured as a neck, such that the insert can be adapted optimally, with its first portion, to the material tube, the nozzle mouthpiece or the heat conducting sleeve of an injection-moulding nozzle and is thus easily pluggable into these parts or is able to be placed—for example in the form of a sleeve—on these parts. The second portion, by contrast, can be adapted optimally to another component, preferably to the mould insert or a mould impression plate, such that problem-free assembly is ensured. The flange can act as a supporting flange, wherein the underside of the flange rests on the mould insert and the top side of the flange bears against the material tube, the nozzle mouthpiece or the heat conducting sleeve. Overall, such a geometry creates a component, the dimensions of which can be adapted optimally to the geometry of the injection-moulding nozzle and of the mould insert while having a minimal overall size.

It is particularly advantageous for the first portion to be formed by the first part and for the second portion to be formed by the second part. In this case, the materials used for the first portion and the second portion can be selected in a targeted manner in accordance with the requirements prevailing in each case.

According to embodiments, this is in particular advantageous when the material of the first portion is a highly heat-conductive material while the material of the second portion is selected to be wear-resistant. As a result of the highly heat-conductive first portion, the flowable melt which is located in the flow duct is kept at a constantly high temperature all the way to the mould impression. At the same time, the more heavily mechanically and abrasively stressed regions on the second portion of the insert are protected from wear by the wear-resistant material. In this case, according to one embodiment, if the wear-resistant material has low heat conductivity, thermal separation of the injection-moulding nozzle from the generally temperature-controlled mould insert furthermore takes place. As a result of the thermal insulation, cooling of the melt in the region of the second portion is avoided effectively.

In a further specific embodiment, the flange is formed by the first part or the second part. In both variants, the flange is formed integrally from one material and has the properties of the respective material. In this way, the flange can for example either continue the heat-conductive function of the first portion or enlarge that region of the second portion that is protected by the wear-resistant material.

According to another embodiment, the flange is formed by the first part and the second part. In this way, the properties of both materials can be combined optimally in a very tight space. Since the flange acts primarily as a supporting flange, it has both regions which are in contact with the mould insert and regions which, depending on the requirements, can bear against the material tube, the nozzle mouthpiece and/or the heat conducting sleeve. In this case, different requirements have to be met in both regions of the flange. While the temperature in the transition region between the flange and the first portion is kept constantly high, at the same time the heat transition from the material tube, the nozzle mouthpiece or the heat conducting sleeve to the mould insert is at a minimum. In addition, it has to be assumed that precisely the contact surfaces are subjected to greater wear, and so greater wear protection is ensured at these points. Since the two parts made of the different materials form the flange, they can at the same time meet contrary requirements in a component in a very small space. This goes in particular also for the insert as a whole.

According to a further advantageous embodiment, the insert forms a centring body for a valve needle of an injection-moulding nozzle. In this case, the insert forms in the first part a wall of the flow duct that tapers conically in the direction of the second neck portion. Such a wall centres the shut-off needle during the closing movement such that the free end of the shut-off needle can always run precisely into its sealing seat. Preferably, the profile of the flow duct in the region of the first part is in this case embodied such that the shut-off needle is already oriented towards the sprue opening of the insert. In this way, excessive wear of the shut-off needle is additionally avoided.

According to a further important embodiment, the second part forms a sealing seat for a valve needle of an injection-moulding nozzle. This can be achieved for example by adapting the diameter of the flow duct in the region of the second portion to the circumference of the valve needle of a needle valve nozzle. Corresponding embodiments have the advantage that the wear to the insert in the region of the second portion, caused by repeated sliding of the valve needle along the surfaces of the flow duct, is considerably reduced in the region of the second portion.

According to a further embodiment, the second part of the insert is configured to form, with the front end, a portion of a wall of a mould impression.

According to a further embodiment, the second part is configured to form, around its outer circumference, at least one sealing surface with the mould insert, wherein the second part has at least one notch in the region of the sealing surface. In this case, the notch can extend for example around the entire circumference of the second part. By way of the notch, a cavity is created in the region of the sealing surface, said cavity allowing at least partial thermal insulation of the second part of the insert from the generally temperature-controlled mould insert. As a result, cooling of the plastics melt in the region of the second portion of the insert on account of heat exchange with the mould insert is reduced further.

Furthermore, the invention relates to an injection-moulding nozzle for an injection mould, having an insert according to the invention. The injection-moulding nozzle can be both a hot runner nozzle and a cold runner nozzle. In this case, the insert can be used both in injection-moulding nozzles with an open sprue and nozzle tip and in injection-moulding nozzles with a heat conducting sleeve and needle valve. Injection-moulding nozzles having the insert according to the invention benefit from the cohesive combination of the different materials of the insert, i.e. only one component has to be handled during assembly. As a result of the cohesive connection of the parts, consisting of two different materials, of the insert, the advantageous properties of the materials can be used in a pinpoint manner and to the best possible extent in a very small overall space.

As a result, for example when a highly heat-conductive material is used in the first part and a wear-resistant material is used in the second part, an optimal temperature distribution can be achieved during the feeding of the melt within the nozzle tip as far as the mould insert, wherein the excellent wear protection property of the second material at the same time allows longer operating times. Since there is a firm connection between the parts of the insert, which even withstands high variations in stress as a result of cooling and heating up of the tool mould, not only is complicated and time-consuming handling avoided by the incorporation of several individual parts, but also a long-lasting and thus cost-effective injection-moulding nozzle is provided.

If the injection-moulding nozzle is a needle valve nozzle, this moreover has the advantage that the insert additionally acts as a centring body because the needle is guided in a stable position and precisely within the insert. In this case, damage to the shut-off needle but also abrasion on the insert is avoided. If the second part of the insert is in this case additionally manufactured from a wear-resistant material, the unexpected wear phenomena are reduced in particular on this part.

The injection-moulding nozzle itself can, in various embodiments, comprise different constituent parts. All embodiments of the injection-moulding nozzle have a material tube in which at least one flow duct is formed which is connected in terms of flow to a mould cavity, formed by at least one mould insert, of the injection mould.

Depending on the embodiment, the injection-moulding nozzle moreover has a heat conducting sleeve which can be embodied as a nozzle mouthpiece. The heat conducting sleeve is inserted into the end of the material tube or is placed on the material tube and forms the outlet opening for the flow duct. The heat conducting sleeve is in this case manufactured from a highly heat-conductive material in order that the melt can be fed to the mould insert at a constantly high temperature without a cold slug, as it is known, arising.

The insert according to the invention is arrangeable at the mould-insert-side end of the material tube, wherein the insert is arrangeable directly in or on the material tube or in or on a separate heat conducting sleeve on the mould-insert side. In this case it is unimportant whether the insert is inserted into or placed on the material tube or the heat conducting sleeve. The first part of the insert body is correspondingly adapted to this end. Furthermore, the insert is formed separately from the rest of the constituent parts of the injection-moulding nozzle and represents a second constituent part of the injection-moulding nozzle. In this way, the two materials of the insert can be selected independently of the materials of the other constituent parts of the injection-moulding nozzle and can be adapted individually to the particular requirements.

In this case, it has proved to be particularly advantageous for the insert to be configured so as to be longitudinally displaceable with regard to the material tube, the nozzle mouthpiece or the heat conducting sleeve and the mould insert and, during operation of the injection-moulding nozzle—i.e. as soon as the tool has reached its operating temperature—to be clamped in place between the material tube and the mould insert, the nozzle mouthpiece and the mould insert or between the heat conducting sleeve and the mould insert. As a result of the longitudinally displaceable fit, it is possible to install and remove the insert quickly and easily. No tools or other aids are necessary to this end. Also, no additional parts or aids, for example a screw thread, screw sleeves or the like, are provided on the insert itself or in the injection-moulding nozzle in order to fasten the insert in the injection-moulding nozzle, because the insert is secured reliably by being clamped in place during operation of the injection-moulding nozzle. The replacement of the insert can nevertheless always take place quickly and cost-effectively.

Furthermore, it is advantageous for the first part to be adapted in its form at least in part to the material tube, the nozzle mouthpiece or the heat conducting sleeve and the second part to be adapted in its form at least in part to the mould insert. As a result of the adaptation in form, a tight connection is always achieved and thus melt is prevented from being able to pass into intermediate spaces, wherein a longitudinal movement of the insert reminds possible in order to be able to compensate for temperature-related changes in position of the injection-moulding nozzle. Thus, the insert forms, with the other parts of the injection-moulding nozzle, a plug system from which the insert can be removed easily without tools by being pulled out, but which at the same time is secured reliably by being clamped in place during operation of the injection-moulding nozzle.

### BRIEF DESCRIPTION OF THE DRAWINGS

Further features, details and advantages of the invention can be gathered from the wording of the claims and from the following description of exemplary embodiments and the embodiments that are illustrated by way of example in the drawings, in which:

FIG. 1 shows a schematic longitudinal section through a first embodiment of an insert according to the invention;

FIG. 2 shows a schematic longitudinal section through another embodiment of an insert according to the invention; and

FIG. 3 shows an enlarged detail of a schematic longitudinal section through yet another embodiment of an insert according to the invention.

### DETAILED DESCRIPTION

In the processing of thermosets and elastomers, where the plastics material cures under the influence of temperature, instead of hot runner systems, cold runner systems are accordingly used. Therefore, where hot runner systems are described in the following text, cold runner systems are also always meant, mutatis mutandis, depending on the application.

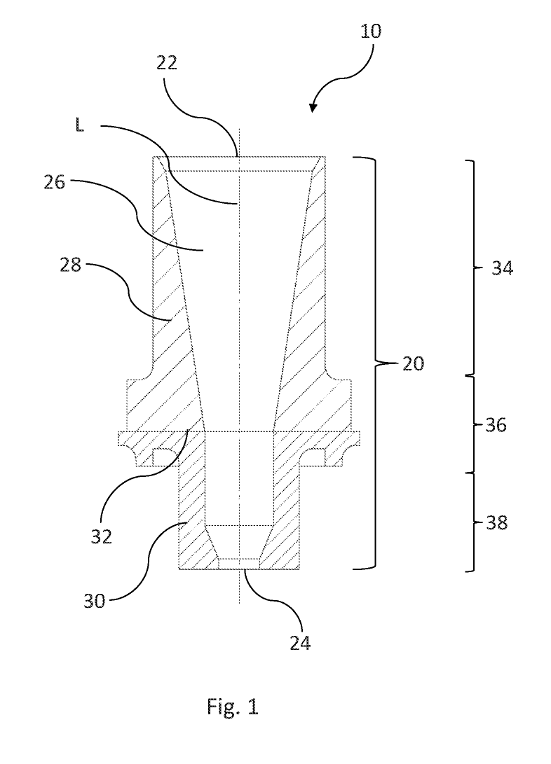

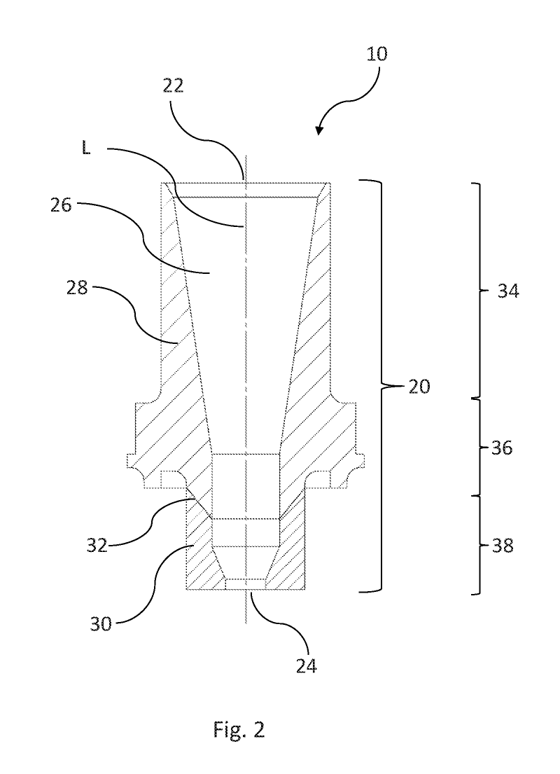

FIGS. 1 and 2 each show a longitudinal section through an insert 10 for an injection-moulding nozzle (not illustrated). The insert 10 is formed in each case by a corresponding insert body 20. In this case, the insert body 20 has a first part 28 having a rear end 22 which can be arranged on an injection-moulding nozzle, for example by being inserted into the injection-moulding nozzle or by being placed on the injection-moulding nozzle. Furthermore, the insert body 20 has a second part 30 having a front end 24 which is adapted to be inserted into a mould insert. Preferably, the second part is embodied in this case such that it forms at its end a portion of the mould impression wall of an injection mould.

The first part 28 of the insert body 20 is in this case connected in a cohesive or form-fitting manner to the second part 30 of the insert body 20 along a contact surface 32. A cohesive connection between the first part 28 of the insert body 20 and the second part 30 of the insert body 20 can be established for example by welding the two parts along the contact surface 32, in particular by diffusion welding. A form-fitting connection could be ensured for example by using a corresponding mechanical arrangement, for example a screw thread, a press fit or a bayonet closure. The first part 28 of the insert body 20 can in this case consist for example of a material which has high thermal conductivity, while the second part 30 of the insert body 20 can consist of a material which has high wear resistance. For example, the second part 30 of the insert body 20 can be made of tool steel.

The insert 10 illustrated in FIG. 1 is embodied so as to be rotationally symmetrical about a longitudinal axis L of the insert 10 and has a first neck portion 34 which is arranged at the rear end 22, and a second neck portion 38 which is arranged at the front end 24. In this case, the first neck portion 34 is embodied such that the insert 10 can be inserted by way of the first neck portion 34 into the material tube, the nozzle mouthpiece or the heat conducting sleeve of an injection-moulding nozzle. At the same time, the second neck portion 38 is adapted such that it can be inserted into the mould insert of an injection mould. Provided between the first neck portion 34 and the second neck portion 38 is a flange 36, which can be used for example as a supporting flange. In this case, the underside of the flange 36 rests on the mould insert of an injection mould, while the top side of the flange bears against the material tube, the nozzle mouthpiece or the heat conducting sleeve of an injection-moulding nozzle.

As illustrated in FIG. 1, the contact surface 32 extends through the flange 36 in the radial direction perpendicularly to the longitudinal axis L of the insert 10. Thus, the first neck portion consists exclusively of the first material, while the second neck portion 38 consists exclusively of the second material. By contrast, the flange 36 is divided in two in terms of its material composition. In an alternative embodiment which is illustrated in FIG. 2, the contact surface 32 extends beneath the flange 36. Furthermore, in the embodiment illustrated here, the contact surface extends obliquely to the longitudinal axis L of the insert 10, such that in the case of a rotationally symmetrical insert 10, a conical profile of the contact surface 32 is produced. In this case, the flange 36 and the first neck portion 34 accordingly consist of the first material, while the second neck portion 38 is made of the second material.

Between the rear end 22 and the front end 24, a flow duct 26 extends through the insert body 20, which is configured to deliver a plastic melt to a mould insert. The flow duct 26 is in this case embodied so as to taper conically in the direction of the front end 24 in the region of the first part 28 of the insert 10. As a result of the conical profile of the flow duct 26, when the insert is used in a needle valve nozzle, a centring effect is achieved for the shut-off part of the needle.

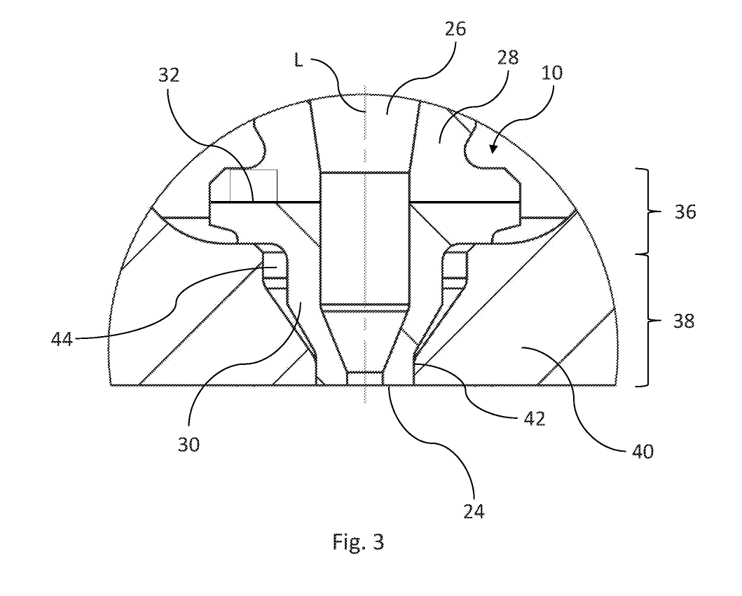

FIG. 3 shows a further longitudinal section through an insert 10. In the embodiment illustrated in FIG. 3, the insert 10 has been fitted into a corresponding opening in a mould insert 40 of an injection mould, such that the front end 24 of the insert forms a portion of the wall of a mould impression located therebeneath. As is further apparent in FIG. 3, the second portion 38 has been inserted into a corresponding recess in the mould insert 40 while the flange 36 is supported on the top side of the mould insert 40. As a result of the size of the recess in the mould insert 40 being adapted to the circumference of the insert 10 in the region of the second portion 38, a sealing surface 42 can be created between the insert 10 and the mould insert 40, as is illustrated in FIG. 3. As a result of the sealing surface 42, during an injection-moulding operation, a reverse flow of the injected plastics material into the region between the insert 10 and the mould insert 40 can be avoided.

In this case, in accordance with the embodiment illustrated in FIG. 3, a notch 44 is provided in the second portion 38 of the insert 10. By way of the notch 44, an air gap is created between the mould insert 40 and the second portion 38 of the insert 10, said air gap allowing at least partial thermal insulation of the insert 10 with respect to the mould insert 40 in the region of the second portion 38. Thus, heat transmission between the mould insert 40 and the insert 10 and thus also between the mould insert 40 and the plastics melt located in the flow duct 26 could be avoided as a result of the notch 44 and the resulting gap between the insert 10 and the mould insert 40.

It can be seen that an insert 10 for the lower end of an injection-moulding nozzle has an insert body 20 which has a rear end 22 and a front end 24 and in which at least one flow duct 26 is formed between the rear end 22 and the front end 24. The insert body 20 has in this case a first part 28 for arranging the insert on or in the injection-moulding nozzle and a second part 30 for arranging on or in a mould insert 40. According to the invention, the first part 28 is manufactured from a first material and extends from the rear end 22 of the insert body 20 to a contact surface 32. The second part 30 is manufactured from a material different from the first material and extends from the contact surface 32 to the front end 24 of the insert body 20. The first part 28 and the second part 30 are furthermore connected firmly together at and/or along the contact surface 32.

All of the features and advantages that are disclosed by the claims, the description and the drawing, including structural design details, spatial arrangements and method steps, may be essential to the invention both on their own and in a wide variety of combinations.

### ADDITIONAL DESCRIPTION

With reference to the figures, further embodiments are discussed:

Embodiment 1 is an insert 10 for an injection-moulding nozzle, having an insert body 20 which has a rear end 22 and a front end 24 and in which at least one flow duct 26 is formed between the rear end 22 and the front end 24, wherein the insert body 20 has a first part 28 for arranging the insert on or in the injection-moulding nozzle and a second part 30 for arranging on or in a mould insert 40, characterized in that the first part 28 is manufactured from a first material and extends from the rear end 22 of the insert body 20 to a contact surface 32, and in that the second part 30 is manufactured from a material different from the first material and extends from the contact surface 32 to the front end 24 of the insert body 20, wherein the first part 28 and the second part 30 are connected together at and/or along the contact surface 32.

Embodiment 2 is an insert according to Embodiment 1, characterized in that the first part 28 and the second part 30 are connected together in a cohesive, form-fitting or frictional manner.

Embodiment 3 is an insert according to any of Embodiments 1 to 2, characterized in that the first part 28 and the second part 30 are connected cohesively together by means of welding.

Embodiment 4 is an insert according to any of Embodiments 1 to 2, characterized in that the first part 28 and the second part 30 are connected together by means of a mechanical connecting arrangement.

Embodiment 5 is an insert according to any of Embodiments 1 to 4, characterized in that the first material is a highly heat-conductive material and the second material is a wear-resistant material.

Embodiment 6 is an insert according to any of Embodiments 1 to 5, characterized in that the contact surface 32 extends perpendicularly or obliquely to the longitudinal axis L of the insert body 20.

Embodiment 7 is an insert according to any of Embodiments 1 to 6, characterized in that the insert body 20 is formed in a rotationally symmetrical manner with respect to the longitudinal axis L and has a first portion 34, a flange 36 and a second portion 38.

Embodiment 8 is an insert according to any of Embodiments 1 to 7, characterized in that the first part 28 of the insert 10 forms a centring body for a valve needle of the injection-moulding nozzle.

Embodiment 9 is an insert according to any of Embodiments 1 to 8, characterized in that the second part forms a sealing seat for a valve needle of the injection-moulding nozzle.

Embodiment 10 is an insert according to any of Embodiments 1 to 9, characterized in that the second part 30 is configured to form, with the front end 24, a portion of the wall of a mould impression.

Embodiment 11 is an insert according to any of Embodiments 1 to 10, characterized in that the second part 30 is configured to form, around its outer circumference, at least one sealing surface 42 with the mould insert 40, wherein the second part 30 has at least one notch 44 in the region of the sealing surface 42.

Embodiment 12 is an injection-moulding nozzle for an injection mould, having an insert 10 according to any of Embodiments 1 to 11.

Embodiment 13 is an injection-moulding nozzle according to Embodiment 12, having a material tube in which at least one flow duct is formed which is connected in terms of flow to a mould cavity, formed by at least one mould insert 40, of the injection mould, characterized in that the insert 10 is arrangeable at the mould-insert-side end of the material tube.

Embodiment 14 is an injection-moulding nozzle according to any of Embodiments 12 to 13, characterized in that the injection-moulding nozzle has a heat conducting sleeve, at the mould-insert-side end of which the insert 10 is arrangeable.

Embodiment 15 is an injection-moulding nozzle according to any of Embodiments 12 to 14, characterized in that the insert 10 is configured so as to be longitudinally displaceable with regard to the material tube, the nozzle mouthpiece or the heat conducting sleeve and the mould insert 40 and, during operation of the injection-moulding nozzle, is clamped in place between the material tube and the mould insert 40, the nozzle mouthpiece and the mould insert 40 or between the heat conducting sleeve and the mould insert 40.

Embodiment 16 is an injection-moulding nozzle according to any of Embodiments 12 to 15, characterized in that the first part is adapted in its form at least in part to the material tube, the nozzle mouthpiece or the heat conducting sleeve and the second portion is adapted in its form at least in part to the mould insert 40.

Embodiment 17 is an injection-moulding nozzle according to any of Embodiments 12 to 16, characterized in that the first part 28 of the insert 10 has a greater coefficient of thermal expansion than the material tube and/or the nozzle mouthpiece and/or the heat conducting sleeve.

### LIST OF REFERENCE SIGNS

L Longitudinal axis
10 Insert
20 Insert body
22 Rear end
24 Front end
26 Flow duct
28 First part
30 Second part
32 Contact surface
34 First neck portion
36 Flange
38 Second neck portion
40 Mould insert
42 Sealing surface
44 Notch

What is claimed is:

1. Insert for an injection-moulding nozzle, having an insert body which has a rear end and a front end and in which at least one flow duct is formed between the rear end and the front end, wherein the insert body has a first part for arranging the insert on or in the injection-moulding nozzle and a second part for arranging on or in a mould insert, characterized in that the first part is manufactured from a first material and extends from the rear end of the insert body to a contact surface, and in that the second part is manufactured from a material different from the first material and extends from the contact surface to the front end of the insert body, wherein the first part and the second part are connected together at and/or along the contact surface.

2. Insert according to claim 1, characterized in that the first part and the second part are connected together in a cohesive, form-fitting or frictional manner.

3. Insert according to claim 1, characterized in that the first part and the second part are connected cohesively together by means of welding.

4. Insert according to claim 1, characterized in that the first part and the second part are connected together by means of a mechanical connecting arrangement.

5. Insert according to claim 1, characterized in that the first material is a highly heat-conductive material and the second material is a wear-resistant material.

6. Insert according to claim 1, characterized in that the contact surface extends perpendicularly or obliquely to a longitudinal axis of the insert body.

7. Insert according to claim 1, characterized in that the insert body is formed in a rotationally symmetrical manner with respect to a longitudinal axis and has a first portion, a flange and a second portion.

8. Insert according to claim 1, characterized in that the first part of the insert forms a centring body for a valve needle of the injection-moulding nozzle.

9. Insert according to claim 8, characterized in that the second part forms a sealing seat for a valve needle of the injection-moulding nozzle.

10. Insert according to claim 1, characterized in that the second part is configured to form, with the front end, a portion of the wall of a mould impression.

11. Insert according to claim 1, characterized in that the second part is configured to form, around its outer circumference, at least one sealing surface with the mould insert, wherein the second part has at least one notch in the region of the sealing surface.

12. Injection-moulding nozzle for an injection mould, having an insert according to claim 1.

13. Injection-moulding nozzle according to claim 12, having a material tube in which at least one flow duct is formed which is connected in terms of flow to a mould cavity, formed by at least one mould insert, of the injection mould, characterized in that the insert is arrangeable at a mould-insert-side end of the material tube.

14. Injection-moulding nozzle according to claim 13, characterized in that the injection-moulding nozzle has a heat conducting sleeve, at the mould-insert-side end of which the insert is arrangeable.

15. Injection-moulding nozzle according to claim 14, characterized in that the insert is configured so as to be longitudinally displaceable with regard to the material tube, a nozzle mouthpiece or the heat conducting sleeve and the mould insert and, during operation of the injection-moulding nozzle, is clamped in place between the material tube and the mould insert, the nozzle mouthpiece and the mould insert or between the heat conducting sleeve and the mould insert.

16. Injection-moulding nozzle according to claim 14, characterized in that the first part is adapted in its form at least in part to the material tube, the nozzle mouthpiece or the heat conducting sleeve and the second portion is adapted in its form at least in part to the mould insert.

17. Injection-moulding nozzle according to one of claim 15, characterized in that the first part of the insert has a greater coefficient of thermal expansion than the material tube and/or the nozzle mouthpiece and/or the heat conducting sleeve.
